(19) United States
(12) Patent Application Publication
(10) Pub. No.: US 2024/0121079 A1
(43) Pub. Date: Apr. 11, 2024

(54) DATA CLEARING ATTESTATION

(71) Applicant: Intel Corporation, Santa Clara, CA (US)

(72) Inventors: Tat Kin Tan, Bayan Lepas (MY); Chew Yee Kee, Bayan Lepas (MY); Boon Khai Ng, Bayan Lepas (MY)

(73) Assignee: Intel Corporation, Santa Clara, CA (US)

(21) Appl. No.: 18/390,958

(22) Filed: Dec. 20, 2023

(51) Int. Cl. H04L 9/06

(52) U.S. Cl. CPC H04L 9/0643

(57) ABSTRACT

One or more non-transitory computer-readable media with instructions stored thereon, wherein the instructions are executable to cause one or more processor units to responsive to a data clear command issued by a tenant of a cloud service provider, issue a plurality of write commands to storage locations utilized by the tenant, the write commands to write a value based on an input provided by the tenant to the storage locations; and provide data read from at least a subset of the storage locations for attestation by the tenant of performance of the data clear command.

### BACKGROUND

A cloud service provider (CSP) may offer various services over the internet to a variety of tenants. Such services may include, e.g., computational resources and storage. In lieu of owning and maintaining their own physical infrastructures, the tenants can temporarily rent the resources of a CSP to accomplish computing objectives.

### BRIEF DESCRIPTION OF THE DRAWINGS

FIG. 1 illustrates an example computing environment comprising a cloud service provider (CSP).

FIG. 2 illustrates creation and encryption of a nonce in a computing environment comprising a CSP.

FIG. 3 illustrates clearing of storage with a hashed nonce in a computing environment comprising a CSP.

FIG. 4 illustrates attestation of data clearing in a computing environment comprising a CSP.

FIGS. 5A-5C illustrate a flow for data clearing attestation.

FIGS. 6A-6C illustrate a flow for allocating, clearing, and attesting storage.

FIG. 7 illustrates an example computing system for use in data clearing attestation.

Like reference numbers and designations in the various drawings indicate like elements.

### DETAILED DESCRIPTION

Modern cloud service providers (CSPs) (such as Amazon AWS®, Microsoft® Azure, Google Cloud Platform™, Alibaba Alicloud®, etc.) may rent out storage spaces (including, but not limited to physical storage devices such as solid state drives (SSDs), hard disk drives (HDDs), 3DXP, redundant array of independent disks (RAID) drives). CSPs may also offer FPGA-as-a-Service (FaaS) (e.g., Amazon AWS® F1 instances) or other suitable configurable logic to tenants. FPGAs are reconfigurable hardware devices that may perform a wide variety of tasks, such as machine learning, signal processing, data acceleration, among others. In some instances, the FPGAs may utilize storage that is separate from a more general storage space rented by the CSP. Similar to the general storage space, the FPGAs and associated storage may store sensitive data. For example, in a multi-tenant FaaS example, a medical insurance company renting an FPGA could configure the FPGA to run complex medical services patient data or a tenant in a of FinTech sector may configure an FPGA to run proprietary algorithms.

The rented storage and computing resources (e.g., FPGAs) may be recycled over time, such that storage space or other resources rented out to one customer may be repurposed for rental to a different customer. A user of the CSP services (referred to herein as tenants) may have to resort to trusting the CSP to erase the data upon rental service completion absent a robust process to provide attestation of the data clearing process to the tenant.

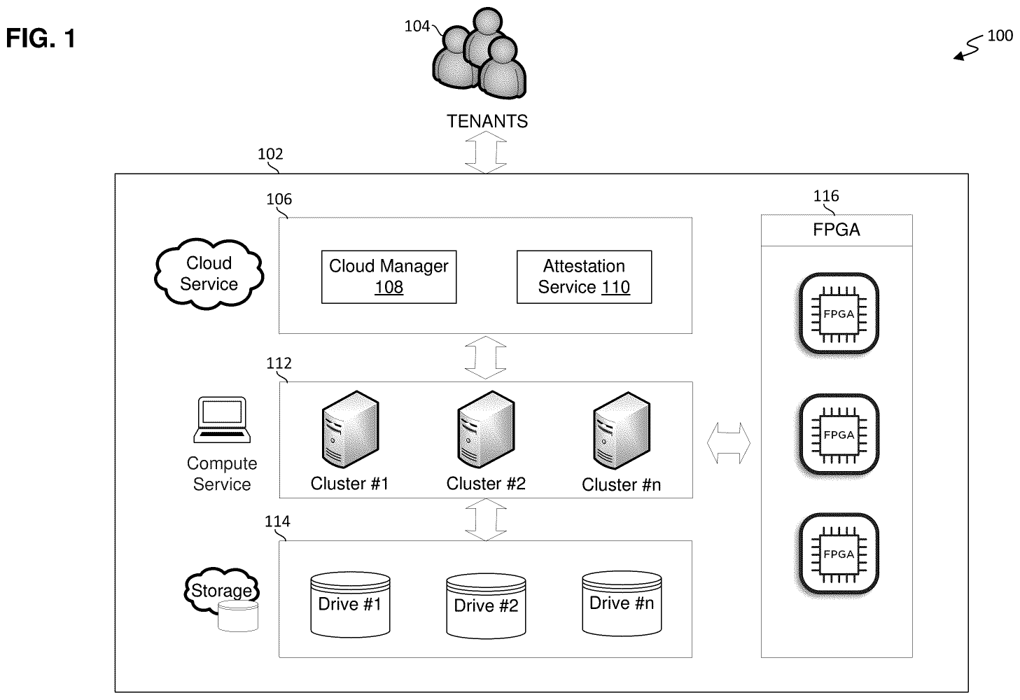

FIG. 1 illustrates an example computing environment 100. The computing environment 100 includes a plurality of tenants 104 that employ services provided by a CSP 102. The CSP 102 includes a cloud service 106 that includes a cloud manager 108 and an attestation service 110. The CSP 102 also includes a compute service 112 comprising computing components, storage service 114 comprising storage drives, and FPGA service 116 comprising FPGAs.

Various embodiments of the present disclosure provide a way to allow a CSP (e.g., 102) to provide attestation to a tenant (e.g., 104) that storage used (e.g., rented) by the tenant has been cleared (e.g., physically erased). The tenant may be involved in the data clearing process to allow the tenant to verify that the clearing has been performed. In some embodiments, the tenant may provide a sequence of input data (e.g., a string of randomized data), referred to herein as a nonce, that is kept confidential and is used as a basis for the erasure of the storage. For example, data based on the nonce may be written over the previous contents of the storage. The tenant may then leverage knowledge of the nonce to read the contents of the storage and confirm that sensitive data in the shared storage has been cleared.

In some embodiments, a public/private key cryptographic scheme may be utilized to provide confidentiality and non-repudiation (e.g., proof of origin, authenticity, and integrity) of the nonce. For example, in various embodiments, a tenant may provide a nonce comprising a string value known only to the tenant, which is securely transmitted to the CSP through public/private key cryptography. The CSP will then hash the nonce and write the resulting hash across the storage space to clear the storage. The hashing of the nonce protects the nonce from being recovered (e.g., the hash is not feasibly reversible) in case the storage is accessed by an unauthorized person. The tenant may then verify that the storage has been cleared by generating a hash value from the original nonce, reading the hash value written to the storage, and comparing the two hashes. If the two hashes are identical, the tenant knows that the previous data in the storage has been overwritten and the attestation of the clearing is completed.

Various embodiments may also give the tenant more control over the timing of the clearing, as in some instances CSPs do not perform data clearing immediately after expiration of a subscription contract and wait to perform the clearing until the storage space is rented out to another tenant (thus increasing the risk of data exposure). Embodiments of the present disclosure may allow a tenant to initiate a clearing at a time of the tenant's choosing. The clearing process may also be simplified significantly. For example, rather than a tenant issuing a plethora of write commands (e.g., to write all 0s or all 1s) across the storage to be cleared, a single clear command could be issued by the tenant and the CSP may perform the clearing across a large volume of data used by the tenant.

A tenant 104 may represent an individual or organization along with one or more computing systems that are used to communicate with the CSP. For example, the tenant 104 may be a customer or other user of the services provided by the CSP 102. In some instances, the customer may rent resources provided by the CSP 102 for a limited period of time.

The cloud manager 108 may provide any suitable logic to interact with tenants 104. The cloud manager 108 may also interact with the compute service 112. In some embodiments, the cloud manager 108 may also communicate with the storage service 114 and/or the FPGA service 116 (either directly or through another medium, such as compute service 112 as shown).

The cloud manager 108 may provide any suitable interface for the tenant to interact with the cloud service provider 102. For example, the cloud manager 108 may provide a web interface (e.g., viewable using a web browser), an application executable by a computing system of a tenant, a command line interface, an application programming interface, and/or other suitable interface to the tenants. In various embodiments, the cloud manager 108 may facilitate offering of a trust as a service feature as part of a service suite of features offered by the CSP.

The cloud manager 108 may interact with the tenants to allow the tenants to set up account details and to request resources (e.g., compute resources of compute service 112, storage resources of storage service 114, and/or FPGA resources of FPGA service 116).

Attestation service 110 may provide any suitable functionality described herein with respect to clearing storage and providing data read from the cleared storage to tenants 104. In some embodiments, attestation service 110 may utilize compute-near-storage to perform any of the cryptographic operations described herein (e.g., including decrypting or hashing).

Compute service 112 may include a variety of computing resources available for use by the tenants 104. Compute service 112 may provide various clusters of computing devices (e.g., central processing units, memories, storage, network controllers, graphics processing units, etc.) that may provide a variety of computing services to tenants. For example, the computing services may include provision of compute instances such as virtual machines, container services, bare metal instances, or other suitable computing services.

The compute service 112 may also include logic to receive requests (e.g., from the cloud service 106 and/or tenants 104), forward the requests to the appropriate computing resources of compute service 112 (or to storage service 114 or FPGA service 116), provision resources for performing the requests, or otherwise facilitate the operation of compute service 112. In some embodiments, computing resources of compute service 112 may, in the course of operation, generate and/or communicate requests to storage service 114 and/or FPGA service 116.

Storage service 114 may include a plurality of storage drives available for use by the tenants 104. For example, the drives may be used in conjunction with compute instances provisioned for the tenants. The drives may include any suitable storage drives, such as hard disk drives, solid state drives, hybrid drives (e.g., comprising both flash memory and magnetic memory), drives comprising phase change memory, or other suitable drives that operate independently or in combination with one or more other drives (e.g., in a RAID array).

The storage service 114 may also include logic to receive requests (e.g., from the cloud service 106, tenants 104, or compute service 112), forward the requests to the appropriate storage resources (e.g., drives) of storage service 114, provision resources for performing the requests, or otherwise facilitate the operation of storage service 114.

FPGA service 116 may include a plurality of FPGAs available for use by the tenants 104. An FPGA may be a semiconductor device that may include configurable logic. An FPGA may be programmed via a data structure (e.g., a bitstream) having any suitable format that defines how the logic is to be configured. An FPGA may be reprogrammed any number of times after the FPGA is manufactured. Configurable logic of an FPGA may be programmed to implement one or more kernels. A kernel may comprise configured logic of the FPGA that may receive a set of one or more inputs, process the set of inputs using the configured logic, and provide a set of one or more outputs. The kernel may perform any suitable type of processing. In various embodiments, a kernel may comprise, e.g., a video processor, an image processor, a waveform generator, a pattern recognition module, a packet processor, an encryptor, a decryptor, an encoder, a decoder, a processor operable to perform any number of operations each specified by a distinct instruction sequence, or other suitable processing function.

Configurable logic of an FPGA may include logic that may be configured to implement one or more kernels. The configurable logic may include any suitable logic, such as any suitable type of logic gates (e.g., AND gates, XOR gates) or combinations of logic gates (e.g., flip flops, look up tables, adders, multipliers, multiplexers, demultiplexers). In some embodiments, the logic is configured (at least in part) through programmable interconnects between logic components of the FPGA.

Operational logic (e.g., on an FPGA or communicatively coupled to an FPGA) may access a data structure defining a kernel and configure the configurable logic of an FPGA based on the data structure. In some embodiments, control bits are written to memory (e.g., nonvolatile flash memory or SRAM based memory) based on the data structure and the control bits operate to configure the logic (e.g., by activating or deactivating particular interconnects between portions of the configurable logic). The operational logic may include any suitable logic (which may be implemented in configurable logic or fixed logic), such as one or more memory devices including any suitable type of memory (e.g., random access memory (RAM)), one or more transceivers, clocking circuitry, one or more processors located on the FPGA, one or more controllers, or other suitable logic.

FPGA service 116 may include one or more memories to facilitate FPGA operation. A memory may be dedicated to a particular FPGA or to a group of the FPGAs of FPGA service 116. The memory may store any suitable data, such as data used by an FPGA (e.g., inputs to an FPGA and/or outputs from an FPGA) and/or a data structure (e.g., bitstream) that is programmed into an FPGA to implement a kernel.

FPGA service 116 may also include logic to receive requests (e.g., from the cloud service 106, tenants 104, or compute service 112), forward the requests to the appropriate resources (e.g., FPGAs) of FPGA service 116, provision resources for performing the requests, or otherwise facilitate the operation of FPGA service 116.

In various situations, any of the storage or memory used by a tenant (whether within compute service 112, storage service 114, or FPGA service 116) may store sensitive information that needs to be cleared.

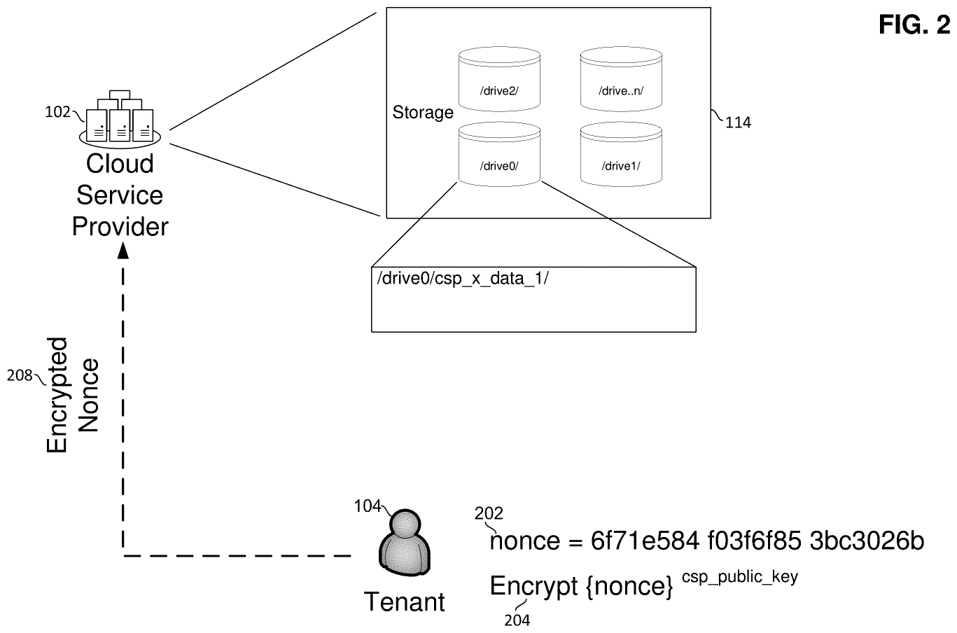

FIG. 2 illustrates creation and encryption of a nonce 202 in a computing environment. A nonce (n) may refer to a value known to a tenant to be used as a basis for a clearing operation. In various embodiments, the nonce may be generated by the tenant, may be a value generated based on input from the tenant, and/or may be provided by the CSP and provided to the tenant. A nonce may comprise a random or pseudorandom value, an alphanumeric value, and/or a string. The nonce may contain a secret value known only by the tenant (and the CSP).

FIG. 2 illustrates communication of the nonce 202 by a tenant 104 to a CSP 102. In this embodiment, the tenant 104 generates a nonce 202. For example, the tenant 104 may generate a customized input string with a random or pseudorandom value as the nonce. In this embodiment, the nonce 202 is a 96 bit hexadecimal number. In other embodiments, the nonce 202 may be any suitable length, e.g., 128 bits, 256 bits, or other suitable length.

Before being transmitted to the CSP 102, the nonce may be encrypted (e.g., at operation 204). For example, the nonce may be encrypted using a public key of the CSP (csp_public_key) to generate a ciphertext (e.g., encrypted nonce 208). A public key may refer to a key of an asymmetric cryptographic key pair that is not private. Anyone with a public key can encrypt a message to produce a ciphertext, but only those with the corresponding private key can decrypt the ciphertext. A public key may be openly distributed.

The nonce 202 may be provided to the CSP 102 at any suitable time and in any suitable manner. In a particular embodiment, the nonce may be entered by the tenant into an interface provided by the CSP, such as a web browser interface, a user interface application with an input text box, or a command line interface. In some embodiments, the interface may accept the nonce as well as any other suitable information from the tenant. For example, in one embodiment, the interface may be provided at the time a tenant signs up to use resources provided by the CSP and thus the interface may also solicit information defining resources to be used by the tenant, a rental length, or other suitable information.

In various embodiments, the interface may accept the nonce as input and may encrypt the nonce (e.g., using the public key of the CSP) on behalf of the tenant before transmission of the nonce to the CSP. In other embodiments, the CSP may provide an infrastructure where the CSP's public key may be easily obtained by the tenant and then used by the tenant to encrypt the nonce before transmission to the CSP. In some embodiments, the tenant may encrypt and/or transmit the nonce to the CSP utilizing an application programming interface (API), e.g., provided by the CSP.

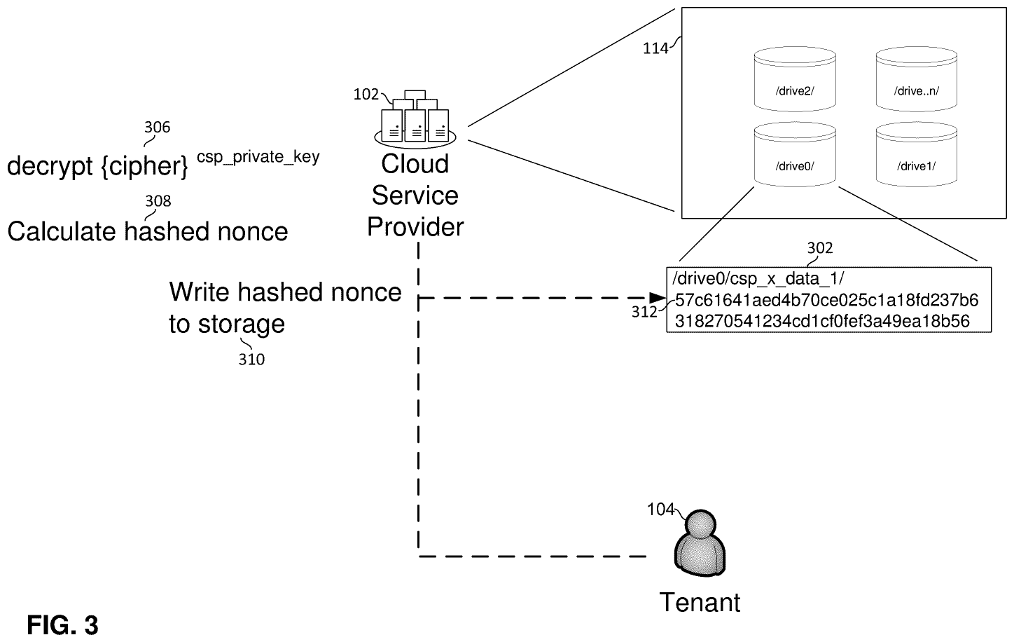

FIG. 3 illustrates clearing of a storage location 302 with a hashed nonce 312 in a computing environment. Upon receiving the ciphertext (e.g., encrypted nonce 208), the CSP 206 may decrypt the nonce at operation 306. For example, the CSP may deploy its private key (csp_private_key) to decrypt the ciphertext 208. A private key may be a key of an asymmetric cryptography key pair that is kept private and may be used to decrypt a message encrypted by a corresponding public key. Since the CSP's private key is not openly known (e.g., it may be known only by the CSP), the tenant 104 may safely assume the ciphertext (e.g., the encrypted nonce 208) is protected in transit and that only the CSP 102 can decrypt the ciphertext and retrieve the value of the nonce 202.

At operation 308, the CSP may then apply a hash function to the decrypted nonce to calculate a hashed nonce 312. For example, at operation 308, a secure hash algorithm 2 (SHA-2) such as SHA-256 is performed with the nonce 202 as input to generate a hashed nonce 312. The hashed nonce 312 is then written to a storage location 302 of a storage drive of storage service 114 at operation 310. Because the hashing operation cryptographically protects the nonce value, the hash data is not reversible and an attacker would not be able to produce the original nonce value.

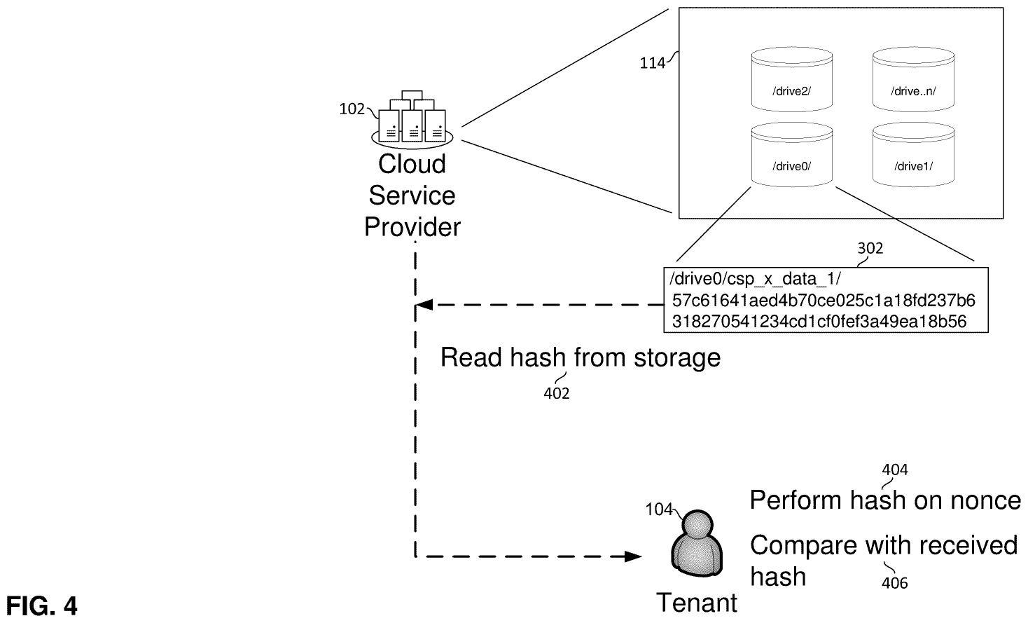

FIG. 4 illustrates attestation of data clearing in a computing environment. When the tenant 104 desires to attest that the storage has been properly cleared (e.g., at the time of rental contract expiration or other suitable time), the tenant 104 may invoke a read operation to retrieve data from the storage location 302. At operation 402, the CSP reads the hash of the nonce from the storage location 302 and returns it to the tenant 104.

At operation 404, the tenant then applies the same hash algorithm that was previously used by the CSP on the original nonce 202 (which the tenant has retained) to generate a hashed nonce. At operation 406, this hashed nonce is then compared with the hashed nonce that was read from storage and returned by the CSP. If these values do not match, then the tenant may assume that the CSP has not properly cleared the storage location 302. If the values are identical, then the tenant knows that the CSP has properly cleared the storage location 302 with the hash calculated based on the tenant's nonce.

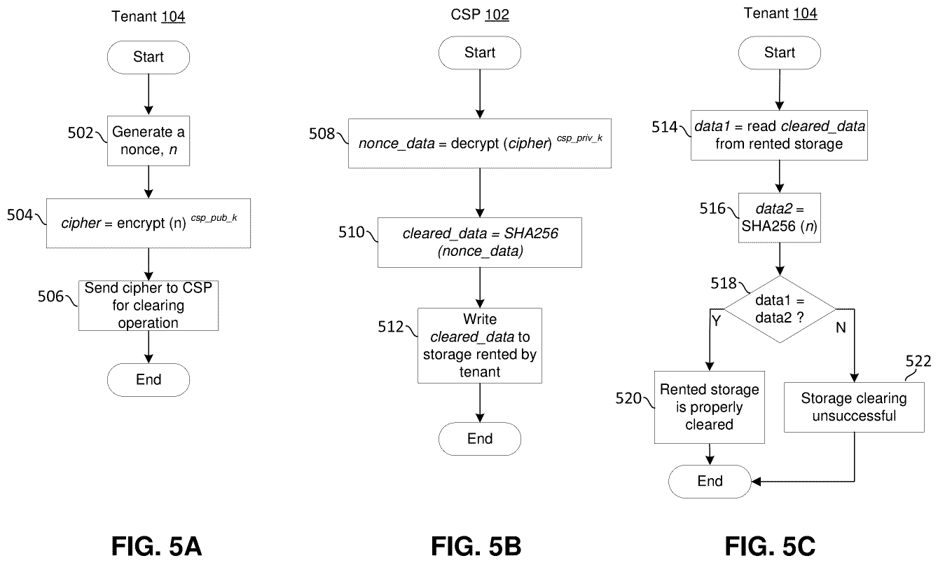

FIGS. 5A-5C illustrate a process for data clearing attestation. FIGS. 5A and 5C represent operations that may be performed by tenant 104 and FIG. 5B represents operations that may be performed by CSP 102. At 502, a nonce n is generated. At 504, the nonce is encrypted using a public key of the CSP to generate a cipher. At 506, the cipher is sent to the CSP for use in a clearing operation.

At 508, the CSP decrypts the cipher using a private key of the CSP to produce a value referred to as nonce_data. At 510, a value referred to as cleared_data is calculated by performing a SHA256 algorithm on the nonce_data value. At 512, the cleared_data value is then written to storage rented by the tenant.

At 514, the tenant sets a data1 value equal to a value (e.g., cleared_value) read from the rented storage. At 516, a data2 value is set equal to the result of a SHA256 algorithm performed by the tenant on the nonce n. At 518 a comparison between data1 and data2 is performed. If the values are equal, the flow moves to 520, where a determination that the rented storage has been properly cleared is made. If the values are not equal, the flow moves to 522, where a determination that the storage clearing was unsuccessful is made.

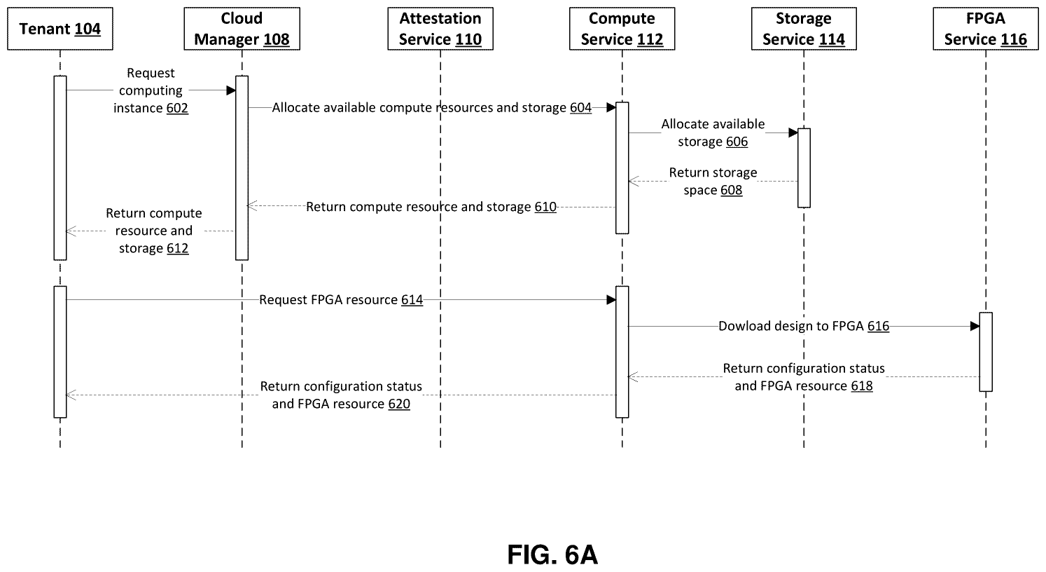

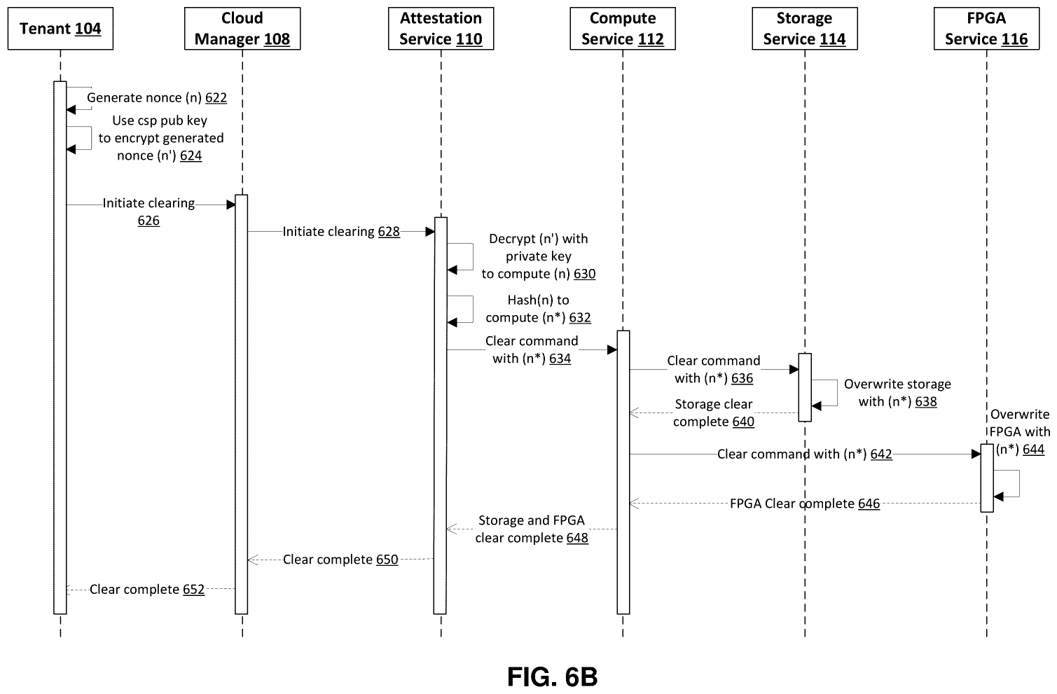

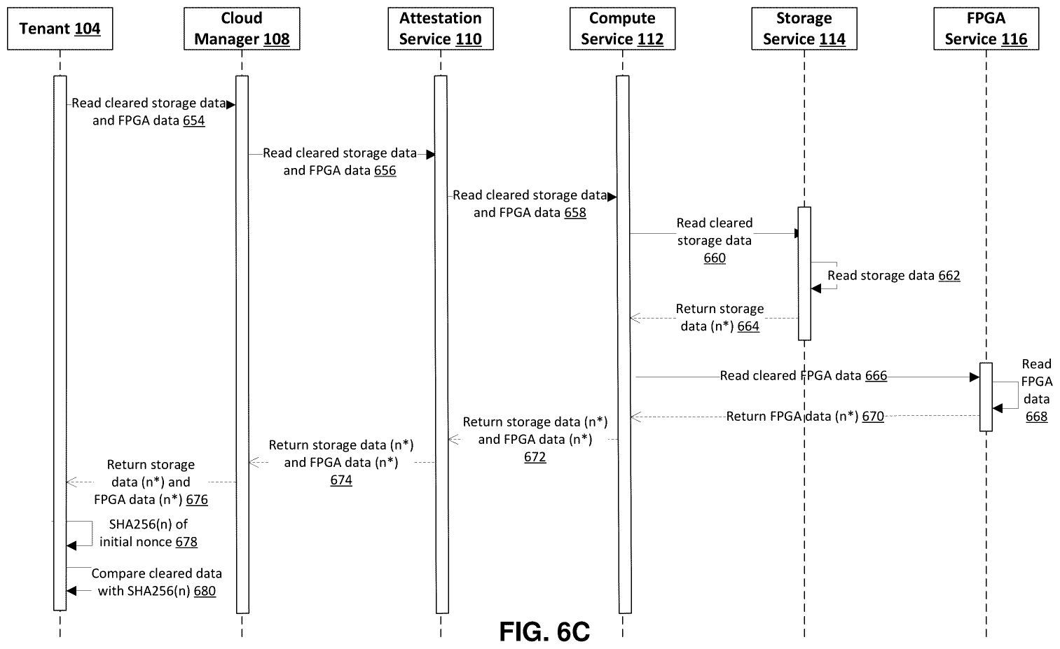

FIGS. 6A-6C illustrate a flow for allocating, clearing, and attesting storage. The flow illustrates example communications that may take place between tenant 104, cloud manager 108, attestation service 110, compute service 112, storage service 114, and FPGA service 116. Although example communications are shown, other embodiments contemplate other communication arrangements. For example, communications sent to or from the cloud manager 108 could alternatively be sent to or from the attestation service, communications forwarded through a particular device (e.g., cloud manager 108, compute service 112) could be sent directly to the intended device or service or through another path. In alternative embodiments, communications may follow an order different from the one laid out herein.

The illustrated flow begins in FIG. 6A. At 602, the tenant 104 requests a computing instance, such as a virtual machine, container, or other suitable computing instance.

At 604, the cloud manager 108 allocates available compute resources and storage resources for the computing instance and communicates this allocation to compute service 112. At 606, the compute service 112 then communicates the allocation of the storage to storage service 114. Alternatively, the cloud manager 108 could communicate this allocation to storage service 114 directly.

At 608, information about the allocated storage space (e.g., information describing how to address the allocated storage space) is returned from the storage service 114 to the compute service 112 at 608 and then information about the allocated compute resources and the allocated storage space is sent to the cloud manager 610 and then returned to the tenant at 612. The information may include any suitable information allowing the tenant 104 to utilize the requested computing instance.

At 614, the tenant 104 sends a request for an FPGA resource to the compute service 112 (e.g., in association with operating the compute instance operated by the tenant 104). Alternatively, the tenant 104 could send a request for the FPGA resource to the cloud manager 108. The request may include a specification of a design for the FPGA, such as a configuration file (e.g., bitstream). At 616, the design information is sent to the FPGA service 116. This design information may be stored at compute service 112 and/or FPGA service and may be used to configure at least one FPGA for the tenant. At 618, a configuration status (e.g., an acknowledgement that the FPGA was successfully configured and is operational) and other suitable information about the FPGA resource is returned to the compute service 112 and then to the tenant at 620.

The flow continues in FIG. 6B. At 622, the tenant generates a nonce. At 624, the tenant uses the CSP's public encryption key to encrypt the nonce.

At 626, the tenant 104 initiates clearing with a request to the cloud manager 108. In some embodiments, the encrypted nonce may be sent to the cloud along with the request to clear data of the tenant. In other embodiments, the encrypted nonce may be sent to the cloud manager in a separate communication. For example, the encrypted nonce may be sent to the cloud manager earlier than the initiation of the clearing (e.g., at the time the tenant requests the computing instance, at the time the tenant signs up with the CSP, or other suitable time).

In various embodiments, the request to initiate clearing may specify a scope of the clearing. For example, the request may specify a particular computing instance (e.g., the instance requested at 602). In some embodiments, the CSP may recognize such a request as a request to clear all storage associated with the particular computing instance (e.g., any storage in compute service 112, storage service 114, and/or FPGA service 116 that was used by or accessible to the computing instance). As another example, the clear request could specify one or more particular storage address ranges. As yet another example, the clear request may specify all storage used by the tenant. As another example, the clear request may specify all storage used by a particular resource (e.g., of a computing instance), such as a particular compute resource of compute service 112 or FPGA of FPGA service 116.

At 628, the clear request may be passed from cloud manager to the attestation service 110. In some embodiments, the clear request may include the encrypted nonce.

At 630, the attestation service 110 decrypts the nonce using the private key of the CSP to generate the nonce. At 632, the attestation service 110 applies a hash to the nonce to compute a hashed nonce. At 634, the attestation service issues a clear command to the compute service 112. The command may include the value (e.g., the hashed nonce) to be written over storage that is to be cleared. Although not shown, the command may initiate the overwriting of memory or storage included within compute service 112 that falls within the scope of the clear.

At 636, the clear command is sent to the storage service 114. At 638, the storage service 114 then overwrites storage locations specified by the clear command using the specified value (e.g., hashed nonce). At 640, the storage service 114 sends a confirmation that the storage clear has been completed.

As the specified value to be used to overwrite storage is likely to be much smaller than the storage to be overwritten, a series of write commands may be issued by any suitable entity (e.g., a controller within the compute service 112 or storage service 114) that specify the same value to be written and address different portions of the storage.

In some embodiments, the value to be written may be repeated multiple times within a write command. For example, if a particular write command is capable of writing a block size of 4096 bytes and the value to be written is 256 bits (32 bytes), the value could be repeated 128 times in a given write command In some embodiments, the value to be written could be included at any suitable location within the data specified by a write command and then padded in either direction by 1s, 0s, alternating 1s and 0s, or some other combination. For example, the data to be written could occupy the n most significant bytes, the n least significant bytes, or other group of bytes within the write data.

In various embodiments, the performance of the write commands result in the underlying physical storage being overwritten and not merely a change in memory pointers to point to a location comprising the desired value (e.g., hashed nonce).

At 642, the compute service 112 sends a clear command with the clear value (e.g., hashed nonce) to the FPGA service 116. At 644, the FPGA service 116 overwrites FPGA storage locations using the specified clear value (e.g., hashed nonce) responsive to the clear command. For example, a storage location storing the configuration file (e.g., bitstream) of an FPGA may be overwritten with the clear value. As another example, a storage location storing input data used by an FPGA or output data from an FPGA may be overwritten with the clear value. In some instances, the clear command may also trigger reprogramming of the configurable logic of an FPGA (e.g., to a default state) such that the functionality previously performed by the FPGA based on the most recently programmed configuration file is no longer performable by the FPGA in the reprogrammed state.

At 646, the FPGA service 116 sends a confirmation that the FPGA clear has been completed to the compute service 112. At 648, the compute service 112 then sends confirmation of the clears to the attestation service 110. A confirmation may then be sent to the cloud manager at 650 and then to the tenant at 652.

The flow continues in FIG. 6C. At 654, the tenant sends a request to the cloud manager 108 to read the cleared storage data and the FPGA data. The request is forwarded to the attestation service 110 at 656 and then to the compute service 112 at 658.

The compute service issues one or more read commands to read the cleared storage at 660. At 662, the storage service reads the specified storage. At 664, the storage data is returned to the compute service 112. If the clearing was performed properly, the hashed nonce (n*) will be returned at this point.

At 666, a request to read the cleared FPGA data is issued to the FPGA service 116 by the compute service 112. The FPGA data is read at 668 and returned at 670.

Although not shown, memory and/or storage of the compute service 112 could also be cleared responsive to the clear request and then later read out to attest that the clear value was written to the memory and/or storage.

The storage data and the FPGA data is returned by the compute service at 672 to the attestation service 110, to the cloud manager at 674, and to the tenant at 676. The tenant may then hash the initial nonce at 678 and compare it with the returned cleared data at 680 to determine whether the clearing was properly performed.

The reading of the cleared data may be implemented in any suitable manner In one embodiment, this may be accomplished by the tenant issuing a series of read commands after the clear. These read commands may have a standard format (e.g., the same format as other read commands issued during execution of the compute instance requested by the user). Indeed, the tenant may issue these reads using compute resources of the compute service 112 rented to the tenant in some instances. These read commands may conform with any suitable storage protocol, such as internet small computer system interface (iSCSI), Fiber Channel (FC), Fibre Channel over Ethernet (FCoE), non-volatile memory express (NVMe), NVMe over fabrics (NVMeoF), or other suitable protocol.

In an extreme case, the tenant may issue read commands for every storage location (e.g., block or other addressable unit) that was cleared and then may perform attestation on every result. In another embodiment, the tenant may issue a sufficient number of reads to various (but not all) cleared storage locations and perform attestation on the results such that the tenant is satisfied that the likelihood that the entire storage was properly cleared is sufficiently high. For example, the tenant may generate a number of random addresses and then issue reads to these addresses and attest the results.

In another embodiment, the CSP may generate the read commands and then provide the results to the tenant via any suitable interface (such as those described above). This may be done responsive to the clear request (e.g., the reads may be performed after the clear is complete and then provided to the tenant in conjunction with an indication that the clear was performed) or responsive to an additional request by the tenant after the clear is performed.

As an example, the CSP may provide a spreadsheet file or a web interface with a table comprising results of the read operations. In some instances, the interface may allow a tenant to choose which storage locations should be read and may perform the reads responsive to input form the tenant. In various embodiments, the CSP may read multiple storage locations and aggregate the results into a single result. For example, since the same value is expected at multiple storage locations, the CSP may perform an XOR operation to combine results read from multiple storage locations and then present the combined result to the tenants. This combined result may then be attested by the tenant.

Once the tenant has attested the proper clearing of the data, the tenant may then send a request to the cloud manager to end the compute instance to release the compute resources, storage, and FPGA resources. Alternatively, the tenant could simply wait for contract expiration after which the compute resources, storage, and FPGA resources will be released for use by a different tenant.

Although the examples described above focus on using a hashed nonce as the clear value, other embodiments contemplate any suitable value to be used as the clear value, including, but not limited to, any suitable value specified by the tenant.

For example, the clear value could be the nonce itself (e.g., any sequence of multiple bits specified by the tenant) or any transformed version of the nonce (where the nonce itself or a transformation thereof may be considered to be “based on” the nonce or specified by the tenant). For example, a value provided by the tenant to the CSP may be transformed (e.g., hashed, encrypted, etc.) in any suitable manner and used as the clear value provided the CSP and tenant both have knowledge of the type of transformation so that the tenant can perform the same transformation to a value in order to attest the clearing operation.

The use of a hash for the transformation may provide an advantage in that the hash value may not be reversible (that is, the original nonce is not recoverable from the hash value). This can provide privacy protection for users who select a nonce based on personal or other sensitive information as well as ensure that the CSP is following the correct clearing procedure (since the hash to generate the clear value is performed independently of the hash performed by the tenant), thus improving confidence in the CSP's clearing procedure.

In various embodiments, any suitable hashing algorithm may be used to generate the clear value from the nonce. For example, the hash algorithm used may be a SHA-2, SHA-3, other SHA algorithm, MD5 (message-digest algorithm), bcrypt, BLAKE2, MAC, digital signature, or other suitable hash function.

In yet other embodiments, the clear value may be all zeros (e.g., utilizing zero filling), all ones, or an alternating pattern of 0s and 1s.

Although examples above describe clearing storage when a tenant is finished using the storage, in some instances the tenant may wish to clear the storage and attest the clearing prior to using the storage (e.g., to avoid any potentially malicious code or data left behind). For example, the tenant may instruct the clearing of a storage used by an FPGA based on a nonce provided by the tenant and then attest the clearing prior to configuring an FPGA.

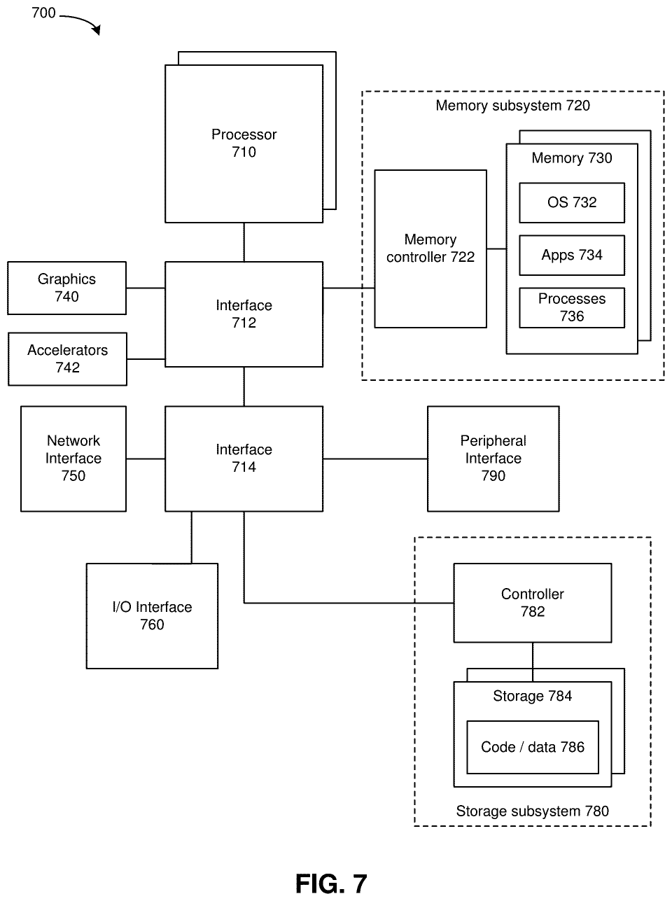

FIG. 7 depicts an example computing system that may be utilized in various embodiments. For example, any suitable depicted component (or group of components) of system 700 may facilitate provision of the functionality of any of the entities depicted in FIG. 1, such as tenant 104 or any of the services or subparts thereof of CSP 102.

System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710. Memory subsystem 720 may include one or more caches, including, e.g., a DDIO area.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a CXL bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, an Ultra Ethernet interface, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. Various embodiments can be used in connection with network interface 750, processor 710, and memory subsystem 720.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714. In various embodiments, memory controller 722 and/or controller 782 may be time aware, that is, they may facilitate the movement of data based on time parameters (e.g., precise time).

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disk may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

Logic may be used to implement any of the flows described or functionality of the various systems or components described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

The embodiments of methods, hardware, software, firmware, or code set forth above may be implemented via instructions or code stored on a machine-accessible, machine readable, computer accessible, or computer readable medium which are executable by a processing element. A machine-accessible/readable medium includes any mechanism that provides (e.g., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Various examples of the embodiments described herein are as follows:

Example 1 includes at least one non-transitory computer-readable media with code stored thereon, wherein the code is executable to cause one or more processor units to responsive to a data clear command issued by a tenant of a cloud service provider, issue a plurality of write commands to storage locations utilized by the tenant, the write commands to write a value based on an input provided by the tenant to the storage locations; and provide data read from at least a subset of the storage locations for attestation by the tenant of performance of the data clear command.

Example 2 includes the subject matter of Example 1, and wherein the value includes a hash value of the input.

Example 3 includes the subject matter of any of Examples 1 and 2, and wherein the code is executable to cause the one or more processor units to calculate the hash value using a SHA-2 hash algorithm.

Example 4 includes the subject matter of any of Examples 1-3, and wherein the data read is provided to the tenant responsive to a plurality of read commands issued by the tenant after provision to the tenant of an indication that the data clear command was performed.

Example 5 includes the subject matter of any of Examples 1-4, and wherein the data read is provided to the tenant responsive to the data clear command.

Example 6 includes the subject matter of any of Examples 1-5, and wherein the storage locations include storage locations coupled to or within a Field Programmable Gate Array (FPGA) utilized by the tenant.

Example 7 includes the subject matter of any of Examples 1-6, and wherein a first write command of the plurality of write commands is issued to a storage drive utilized by the tenant and wherein a second write command of the plurality of write commands is issued to storage used by an FPGA utilized by the tenant.

Example 8 includes the subject matter of any of Examples 1-7, and wherein a first write command of the plurality of write commands is used to overwrite at least a portion of a configuration file used to configure configurable logic of an FPGA.

Example 9 includes the subject matter of any of Examples 1-8, and wherein the input provided by the tenant is provided separately from the data clear command.

Example 10 includes an apparatus comprising a memory to store a value specified by a tenant of a cloud service provider; first circuitry to, responsive to a data clear command issued by the tenant, issue a plurality of write commands to storage locations utilized by the tenant, the write commands instructing the writing of the value to the storage locations; and second circuitry to provide data read from at least a subset of the storage locations for attestation by the tenant of performance of the data clear command.

Example 11 includes the subject matter of Example 10, and wherein the value includes a hash value of input provided by the tenant.

Example 12 includes the subject matter of any of Examples 10 and 11, and wherein the hash value is calculated using a SHA-2 hash algorithm.

Example 13 includes the subject matter of any of Examples 10-12, and wherein the data read is provided to the tenant responsive to a plurality of read commands issued by the tenant after provision to the tenant of an indication that the data clear command was performed.

Example 14 includes the subject matter of any of Examples 10-13, and wherein the data read is provided to the tenant responsive to the data clear command.

Example 15 includes the subject matter of any of Examples 10-14, and wherein a first write command of the plurality of write commands is issued to a storage drive utilized by the tenant and wherein a second write command of the plurality of write commands is issued to storage used by an FPGA utilized by the tenant.

Example 16 includes the subject matter of any of Examples 10-15, and wherein the storage locations include storage locations coupled to or within a Field Programmable Gate Array utilized by the tenant.

Example 17 includes the subject matter of any of Examples 10-16, and wherein the second circuitry is to provide the read data via a web interface, wherein the data clear command was issued by the tenant via the web interface.

Example 18 includes the subject matter of any of Examples 10-17, and wherein a first write command of the plurality of write commands is used to overwrite at least a portion of a configuration file used to configure configurable logic of an FPGA.

Example 19 includes the subject matter of any of Examples 10-18, and wherein the value is not specified in the data clear command.

Example 20 includes a system comprising a compute service comprising a plurality of compute resources usable by a plurality of tenants; a storage service comprising a plurality of storage drives usable by the plurality of tenants; and a cloud service to responsive to a data clear command issued by a tenant of the plurality of tenants, issue a plurality of write commands to storage locations of at least one storage drive of the plurality of storage drives, the write commands to write a value specified by the tenant to the storage locations; and provide data read from at least a subset of the storage locations for attestation by the tenant of performance of the data clear command.

Example 21 includes the subject matter of Example 20, and wherein the value includes a hash value of an input provided by the tenant.

Example 22 includes the subject matter of any of Examples 20 and 21, and wherein the hash value is calculated using a SHA-2 hash algorithm.

Example 23 includes the subject matter of any of Examples 20-22, and wherein the data read is provided to the tenant responsive to a plurality of read commands issued by the tenant after provision to the tenant of an indication that the data clear command was performed.

Example 24 includes the subject matter of any of Examples 20-23, and wherein the cloud service is to provide the data read to the tenant responsive to the data clear command.

Example 25 includes the subject matter of any of Examples 20-24, the system further comprising a field programmable gate array (FPGA) service comprising a plurality of FPGAs usable by the plurality of tenants.

Example 26 includes the subject matter of any of Examples 20-25, and wherein a first write command of the plurality of write commands is issued to a storage drive of the plurality of storage drives and wherein a second write command of the plurality of write commands is issued to storage used by an FPGA of the plurality of FPGAs.

Example 27 includes the subject matter of any of Examples 20-26, and wherein the storage locations include storage locations coupled to or within an FPGA of the plurality of FPGAs.

Example 28 includes the subject matter of any of Examples 20-27, and wherein a first write command of the plurality of write commands is used to overwrite at least a portion of a configuration file used to configure configurable logic of an FPGA of the plurality of FPGAs.

Example 29 includes the subject matter of any of Examples 20-28, and wherein the cloud service is to provide the read data via a web interface, wherein the data clear command was issued by the tenant via the web interface.

Example 30 includes the subject matter of any of Examples 20-29, and wherein the value is not specified in the data clear command.

Example 31 includes a non-transitory computer-readable medium containing program instructions for data clearing attestation in a cloud service environment, wherein execution of the program instructions by one or more processors of a cloud service provider (CSP) system causes the CSP system to perform steps comprising a) receiving an encrypted nonce value from a tenant, wherein the nonce value is encrypted using a public key of the CSP; b) decrypting the encrypted nonce value using a private key corresponding to the public key of the CSP to retrieve the nonce value; c) generating a hash value based on the nonce value; d) writing the hash value to a specified storage space previously rented by the tenant to perform data clearing; and e) providing access to the tenant to read the hash value from the specified storage space for attestation of the data clearing.

Example 32 includes the subject matter of Example 31, and wherein the program instructions further cause the CSP system to perform steps comprising a) receiving a verification request from the tenant after the expiration of a rental contract; b) allowing the tenant to retrieve the hash value from the specified storage space; and c) enabling the tenant to compare the retrieved hash value with a tenant-generated hash value to verify the data clearing attestation.

Example 33 includes the subject matter of any of Examples 31 and 32, and wherein the program instructions further cause the CSP system to perform steps comprising a) providing a user interface for the tenant to input the nonce value; and b) encrypting the nonce value with the CSP's public key to generate the encrypted nonce value.

Example 34 includes the subject matter of any of Examples 31-33, and wherein the program instructions further cause the CSP system to perform steps comprising a) maintaining a public/private key infrastructure for secure communication of the nonce value between the tenant and the CSP; and b) ensuring confidentiality and non-repudiation of the nonce value during the data clearing attestation process.

Example 35 includes the subject matter of any of Examples 31-34, and wherein the program instructions further cause the CSP system to perform steps comprising implementing a cryptographic erase (CE) process that utilizes the nonce value to sanitize a media encryption key (MEK) associated with the specified storage space.

Example 36 includes the subject matter of any of Examples 31-35, and wherein the program instructions further cause the CSP system to perform steps comprising providing a certificate of data clearing attestation to the tenant upon successful verification of the data clearing.

Example 37 includes the subject matter of any of Examples 31-36, and wherein the program instructions are further executable to implement the data clearing attestation process across multiple storage spaces within a cloud storage environment, including but not limited to solid-state drives (SSDs), hard disk drives (HDDs), Flash, NAND, NOR, 3D x-point, and redundant array of independent disks (RAID) configurations.

What is claimed is:

1. One or more non-transitory computer-readable media with instructions stored thereon, wherein the instructions are executable to cause one or more processor units to:
responsive to a data clear command issued by a tenant of a cloud service provider, issue a plurality of write commands to storage locations utilized by the tenant, the write commands to write a value based on an input provided by the tenant to the storage locations; and
provide data read from at least a subset of the storage locations for attestation by the tenant of performance of the data clear command.

2. The media of claim 1, wherein the value includes a hash value of the input.

3. The media of claim 2, wherein the code is executable to cause the one or more processor units to calculate the hash value using a SHA-2 hash algorithm.

4. The media of claim 1, wherein the data read is provided to the tenant responsive to a plurality of read commands issued by the tenant after provision to the tenant of an indication that the data clear command was performed.

5. The media of claim 1, wherein the data read is provided to the tenant responsive to the data clear command.

6. The media of claim 1, wherein the storage locations include storage locations coupled to or within a Field Programmable Gate Array (FPGA) utilized by the tenant.

7. The media of claim 1, wherein a first write command of the plurality of write commands is issued to a storage drive utilized by the tenant and wherein a second write command of the plurality of write commands is issued to storage used by an FPGA utilized by the tenant.

8. The media of claim 1, wherein a first write command of the plurality of write commands is used to overwrite at least a portion of a configuration file used to configure configurable logic of an FPGA.

9. The media of claim 1, wherein the input provided by the tenant is provided separately from the data clear command.

10. An apparatus comprising:
a memory to store a value specified by a tenant of a cloud service provider;
first circuitry to, responsive to a data clear command issued by the tenant, issue a plurality of write commands to storage locations utilized by the tenant, the write commands instructing the writing of the value to the storage locations; and
second circuitry to provide data read from at least a subset of the storage locations for attestation by the tenant of performance of the data clear command.

11. The apparatus of claim 10, wherein the value includes a hash value of input provided by the tenant.

12. The apparatus of claim 10, wherein a first write command of the plurality of write commands is issued to a storage drive utilized by the tenant and wherein a second write command of the plurality of write commands is issued to storage used by an FPGA utilized by the tenant.

13. The apparatus of claim 10, wherein the storage locations include storage locations coupled to or within a Field Programmable Gate Array utilized by the tenant.

14. The apparatus of claim 10, wherein the second circuitry is to provide the read data via a web interface, wherein the data clear command was issued by the tenant via the web interface.

15. A system comprising:
a compute service comprising a plurality of compute resources usable by a plurality of tenants;
a storage service comprising a plurality of storage drives usable by the plurality of tenants; and
a cloud service to:
responsive to a data clear command issued by a tenant of the plurality of tenants, issue a plurality of write commands to storage locations of at least one storage drive of the plurality of storage drives, the write commands to write a value specified by the tenant to the storage locations; and
provide data read from at least a subset of the storage locations for attestation by the tenant of performance of the data clear command.

16. The system of claim 15, wherein the value includes a hash value of an input provided by the tenant.

17. The system of claim 15, wherein the cloud service is to provide the data read to the tenant responsive to the data clear command.

18. The system of claim 15, the system further comprising a field programmable gate array (FPGA) service comprising a plurality of FPGAs usable by the plurality of tenants.

19. The system of claim 18, wherein a first write command of the plurality of write commands is issued to a storage drive of the plurality of storage drives and wherein a second write command of the plurality of write commands is issued to storage used by an FPGA of the plurality of FPGAs.

20. The system of claim 18, wherein a first write command of the plurality of write commands is used to overwrite at least a portion of a configuration file used to configure configurable logic of an FPGA of the plurality of FPGAs.
